(19) United States
(12) Patent Application Publication
(10) Pub. No.: US 2006/0269197 A1
(43) Pub. Date: Nov. 30, 2006

(54) Bidirectional optical module and light transmitting apparatus

(75) Inventors: Hitoshi Uno, Yokohama-shi (JP); Hiroaki Asano, Yokohama-shi (JP); Hironori Souda, Hirakata-shi (JP); Syougo Horinouchi, Fukuoka-shi (JP); Toshinori Kai, Yamaga-shi (JP); Toshihiro Koga, Kikuchi-gun (JP); Masaharu Fukakusa, Kobayashi-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 10/547,768

(22) PCT Filed: Mar. 5, 2004
(86) PCT No.: PCT/JP04/02797

§ 371 Date: Sep. 2, 2005

(30) Foreign Application Priority Data
Mar. 10, 2003 (JP) 2003-062599

(51) Int. Cl. G02B 6/36

(52) U.S. Cl. 385/93

(57) ABSTRACT

In a bidirectional optical module, a technique for attaining a miniaturization and a lower cost of a bidirectional optical module in which one optical fiber propagation path can be bused in two ways is disclosed. According to this technique, a molded product 12 is made of a transparent material, and a beam splitter layer 121 is inclined and embedded. A sub carrier 15 has a stage portion constituting an upper stage and a lower stage and is mounted on a flat top plane of a carrier 19. A semiconductor laser 14 is mounted on the upper stage of the sub-carrier, and a light receiving device 13 is mounted at a lower position of the molded product on the lower stage, and a side of the molded product is mounted on the side, and the respective planes are consequently bonded.

### TECHNICAL FIELD

The present invention relates to an optical module in which one optical waveguide can be used in two ways, and a light transmitting apparatus that uses the same.

### BACKGROUND ART

The application range of an optical fiber communication using a semiconductor laser has been widely spread to various fields such as LAN (Local area network) and FTTH (fiber to the home) in recent years. In the LAN and the FTTH, because of the form of provided services, there are many cases where a bidirectional communication is required. So, realizing the bidirectional communication by using one optical fiber is considered to have various merits.

As one of the conventional configuration examples of the bidirectional optical unit for executing the bidirectional communication by using one optical fiber, there is the example as shown in FIG. 25. That is, a light transmitting module 3 and a light receiving module 4 are coupled through an optical fiber coupler 5 to an optical fiber propagation path 2. Such an example can be easily configured by using existing optical parts. However, this does not sufficiently answer the subjects of the miniaturization of the bidirectional optical unit and the low cost.

So, a bidirectional optical module where a receiving unit and a transmitting unit are integrated into a single unit is proposed. As its conventional example, for example, there is a technique noted in the following patent document 1. This is configured such that a light emitting device, a collimate lens for collimating the output lights from the light emitting device, a light receiving device, a collective lens for coupling the lights to the light receiving device, an optical fiber terminal, a common port lens for collimating the lights outputted from an optical fiber, and a pentagonal prism block where a filter for dividing and combining the lights depending on a wavelength is mounted are accommodated or connected in one metal case.

Patent Document 1: Patent No.1758757

However, in the bidirectional optical module disclosed in the patent document 1, the part number of the optical parts accommodated in one metal case is great, which results in a problem that this cannot still sufficiently answer the further miniaturization and the lower cost.

### DISCLOSURE OF THE INVENTION

The present invention solves the foregoing problems and has an object to provide a bidirectional optical module suitable for the miniaturization and the lower cost, and a light transmitting apparatus using the module.

In order to attain the foregoing object, the invention according to claim 1 is configured as a bidirectional optical module including:

a lens for transmitting and collecting a received light and a transmitting light;

a carrier having a flat plane in at least a part;

a sub-carrier having a stage portion constituting an upper stage and a lower stage, and a bottom plane, in which the bottom plane is bonded to the flat plane of said carrier;

a light emitting device, which is mounted on the upper stage of the sub-carrier and horizontally outputs the transmitting light;

a transparent molded product whose one plane is bonded to at least a part of one plane of the sub-carrier;

a beam splitter layer that is embedded in the molded product at a predetermined angle, and downwardly transmits the received light from above which is transmitted through the lens, and also upwardly reflects an output light of the light emitting device, and gives to the lens; and

a light receiving device that is mounted directly or through a different member on the lower stage of the sub-carrier, at a lower position of the transparent molded product, and receives the received light from above that is transmitted through the beam splitter layer.

With this configuration, the light receiving signal guided into this optical module from the optical waveguide can be collected by the lens, and inputted to the light receiving device placed at the very close position to the semiconductor laser which is the light emitting device, and the signal can be received. Thus, as compared with the conventional bidirectional optical module, it can be configured by the smaller number of the parts, and the miniaturization and the lower cost can be attained. Also, in the configuration where the foregoing semiconductor laser and light receiving device are placed in the close positions, the position to optimize the optical transmission/reception property is reduced. Hence, the case in which a high precision is required to mount the semiconductor laser may be considered. However, in the configuration of the present invention, by displacing the joint plane between the molded product and the sub-carrier and adjusting the position relation between the sub-carrier and the lens, it is possible to optimize the optical transmission/reception property and consequently possible to relax the mounting precision of the semiconductor laser.

In order to attain the foregoing objects, the invention according to claim 2 is configured as a bidirectional optical module, including:

a lens for transmitting and collecting a received light and a transmitting light;

a carrier having a flat plane in at least a part;

a supporting member that is fixed to the carrier and has a plane inclined against the flat plane at a predetermined angle;

a sub-carrier having a stage portion constituting an upper stage and a lower stage, and a bottom plane, in which the bottom plane is bonded to the flat plane of the carrier;

a light emitting device, which is mounted on the upper stage of the sub-carrier and horizontally outputs the transmitting light;

a transparent molded product whose one plane is bonded to at least a part of the inclined plane of the supporting member;

a beam splitter layer that is attached to the molded product, and downwardly transmits the received light from above which is transmitted through the lens, and also upwardly reflects an output light of the light emitting device, and gives to the lens; and

a light receiving device that is mounted directly or through a different member on the lower stage of the sub-carrier, at a lower position of the transparent molded product, and receives the received light from above that is transmitted through the beam splitter layer.

With this configuration, the same action and effect as the invention according to claim 1 is obtained.

In order to attain the foregoing objects, the invention according to claim 3 is configured as a bidirectional optical module, including:

a lens for transmitting and collecting a received light and a transmitting light;

a carrier having a flat plane in at least a part;

a supporting member fixed to the carrier;

a sub-carrier having a stage portion constituting an upper stage and a lower stage, and a bottom plane, in which the bottom plane is bonded to the flat plane of the carrier;

a light emitting device, which is mounted on the upper stage of the sub-carrier and horizontally outputs the transmitting light;

a transparent molded product whose one plane is bonded to at least a part of one plane of the supporting member;

a beam splitter layer that is obliquely embedded in the molded product at a predetermined angle, and downwardly transmits the received light from above which is transmitted through the lens, and also upwardly reflects an output light of the light emitting device, and gives to the lens; and

a light receiving device that is mounted directly or through a different member on the lower stage of the sub-carrier, at a lower position of the transparent molded product, and receives the received light from above that is transmitted through the beam splitter layer.

With this configuration, the same action and effect as the invention according to claim 1 is obtained.

In order to attain the foregoing objects, the invention according to claim 4 is configured as a bidirectional optical module, including:

a lens for transmitting and collecting a received light and a transmitting light;

a carrier having a flat plane in at least a part;

a sub-carrier that has an inclination plane inclined against the flat plane at a predetermined angle, and a top plane and a bottom plane, in which the bottom plane is bonded to the flat plane of the carrier;

a light emitting device, which is mounted on the top plane of the sub-carrier and horizontally outputs the transmitting light;

a transparent molded product whose one plane is bonded to at least a part of the inclination plane of the sub-carrier;

a beam splitter layer that is attached to the molded product, and downwardly transmits the received light from above which is transmitted through the lens, and also upwardly reflects an output light of the light emitting device, and gives to the lens; and

a light receiving device that is mounted directly or through a different member on the flat plane of the carrier, at a lower position of the transparent molded product, and receives the received light from above that is transmitted through the beam splitter layer.

With this configuration, the same action and effect as the invention according to claim 1 is obtained.

In order to attain the foregoing objects, the invention according to claim 5 is configured as a bidirectional optical module, including:

a lens for transmitting and collecting a received light and a transmitting light;

a carrier having a flat plane in at least a part;

a sub-carrier having a top plane and a bottom plane, in which the bottom plane is bonded to the flat plane of the carrier;

a light emitting device, which is mounted on the top plane of the sub-carrier and horizontally outputs the transmitting light;

a transparent molded product whose one plane is bonded to at least a part of one plane of the sub-carrier;

a beam splitter layer that is embedded in the molded product at a predetermined angle, and downwardly transmits the received light from above which is transmitted through the lens, and also upwardly reflects an output light of the light emitting device, and gives to the lens; and

a light receiving device that is mounted directly or through a different member on the flat plane of the carrier, at a lower position of the transparent molded product, and receives the received light from above that is transmitted through the beam splitter layer.

With this configuration, the same action and effect as the invention according to claim 1 is obtained.

In order to attain the foregoing objects, the invention according to claim 6 is configured as a bidirectional optical module, including:

a lens for transmitting and collecting a received light and a transmitting light;

a carrier having a flat plane in at least a part;

a supporting member that is fixed to the carrier and has a plane inclined against the flat plane at a predetermined angle;

a sub-carrier having a top plane and a bottom plane, in which the bottom plane is bonded to the flat plane of the carrier;

a light emitting device, which is mounted on the top plane of the sub-carrier and horizontally outputs the transmitting light;

a transparent molded product whose one plane is bonded to at least a part of the inclined plane of the supporting member;

a beam splitter layer that is attached to the molded product, and downwardly transmits the received light from above which is transmitted through the lens, and also upwardly reflects an output light of the light emitting device, and gives to the lens; and

a light receiving device that is mounted directly or through a different member on the flat plane of the carrier, at a lower position of the transparent molded product, and receives the received light from above that is transmitted through the beam splitter layer.

With this configuration, the same action and effect as the invention according to claim 1 is obtained.

The invention according to claim 7 is such that in the bidirectional optical module according to any one of the preceding claims 1 to 6, the predetermined angle is approximately 45°.

With this configuration, the same action and effect as the invention according to claim 1 is obtained.

The invention according to claim 8 is such that in the bidirectional optical module according to any one of the preceding claims 4 to 6, the carrier is conductive, an N-side electrode of the light receiving device is formed on the bottom plane of the light receiving device, the N-side electrode is bonded through a conductive adhesive to a surface of the carrier, and a P-side electrode of the light receiving device is formed on the top plane of the light receiving device.

With this configuration, the same action and effect as the invention according to claim 1 is obtained.

The invention according to claim 9 is such that in the bidirectional optical module according to any one of the preceding claims 4 to 6, both of the P-side electrode and N-side electrode of the light receiving device are formed on the top plane of the light receiving device, and the P-side electrode and N-side electrode are electrically insulated from the carrier.

With this configuration, in addition to the obtainment of the same action and effect as the invention according to claim 1, it is possible to separate a potential of the carrier and a potential of the light receiving device.

The invention according to claim 10 is such that in the bidirectional optical module according to any one of the preceding claims 1 to 6, a pre-amplifier for amplifying a light receiving signal is placed in the vicinity of the light receiving device on the carrier.

With this configuration, in addition to the obtainment of the same action and effect as the invention according to the preceding claims 1 to 9, the pre-amplifier is built in the module, and the pre-amplifier and the light receiving device are placed at the close positions. Thus, a module package can be used as a shield case, and the connection between the light receiving device and the pre-amplifier can be made shorter, thereby improving the noise resistance.

The invention according to claim 11 is such that in the bidirectional optical module according to any one of the preceding claims 1 to 6, as the different member, a pre-amplifier that is mounted on a surface of the carrier or the sub-carrier and amplifies the light receiving signal generated by the light receiving device is used.

With this configuration, the same action and effect as the invention according to claim 10 is obtained.

The invention according to claim 12 is such that in the bidirectional optical module according to any one of the preceding claims 1 to 6, the sub-carrier is made of silicon.

With this configuration, the heat dissipation property of the semiconductor laser can be improved.

The invention according to claim 13 is such that in the bidirectional optical module according to any one of the preceding claims 1 to 6, the sub-carrier is made of aluminum nitride.

With this configuration, the heat dissipation property of the semiconductor laser can be improved.

The according to claim 14 is such that in the bidirectional optical module according to any one of the preceding claims 1 to 6, a reflection protecting film is formed on a light input plane of the molded product and a part or whole of a light output plane.

With this configuration, the attenuation of the transmitting/receiving light amount caused by reflection can be reduced, and if the light emitting plane of the semiconductor laser is substantially parallel to one plane of the molded product, the external resonation of the semiconductor laser can be suppressed.

The invention according to claim 15 is such that in the bidirectional optical module according to claim 1 or 4, a refractive index matching resin is filled between the light receiving device and the molded product.

With this configuration, if the light emitting plane of the semiconductor laser is substantially parallel to the input plane of the molded product, filling the refractive index matching resin between them can suppress the external resonation of the semiconductor laser.

The invention according to claim 16 is such that in the bidirectional optical module according to any one of the preceding claims 1 to 6, the beam splitter divides a predetermined wavelength by a preset rate.

With this configuration, the bidirectional optical module of the same wavelength can be attained.

The invention according to claim 17 is such that in the bidirectional optical module according to any one of the preceding claims 1 to 6, as the beam splitter, a wavelength selection type beam splitter is used.

With this configuration, the bidirectional optical module of two wavelengths can be attained.

The invention according to claim 18 is such that in the bidirectional optical module according to any one of the preceding claims 1 to 6, a second molded product having a wavelength selection type beam splitter layer for reducing a light of a wavelength that should not be received by the light receiving device is stuck on a part or whole of a surface of the molded product.

With this configuration, the light of the wavelength that should not be received by the light receiving device can be reduced.

The invention according to claim 19 is such that in the bidirectional optical module according to any one of the preceding claims 1 to 6, a wavelength selection type beam splitter layer for reducing a light of a wavelength that should not be received by the light receiving device is additionally formed on a part or whole of an inside or surface of the molded product.

With this configuration, the light of the wavelength that should not be received by the light receiving device can be reduced.

The invention according to claim 20 is such that in the bidirectional optical module according to any one of the preceding claims 1 to 6, the light receiving device has a wavelength selection property for reducing a light of a wavelength that should not be received.

With this configuration, the light of the wavelength that should not be received by the light receiving device can be reduced.

The invention according to claim 21 is such that in the bidirectional optical module according to any one of the preceding claims 1 to 6, a second molded product having a wavelength selection type beam splitter layer for reducing a light of a wavelength that should not be received by the light receiving device is stuck on a part or whole of a light input plane of the light receiving device.

With this configuration, the light of the wavelength that should not be received by the light receiving device can be reduced.

The invention according to claim 22 is such that in the bidirectional optical module according to any one of the preceding claims 1 to 6, the lens and an optical waveguide are bonded with refractive index matching resin.

With this configuration, even if an optical waveguide edge plane is not obliquely processed, the reflection on the optical waveguide edge plane can be greatly reduced.

The invention according to claim 23 is such that in the bidirectional optical module according to any one of the preceding claims 1 to 6, the lens and optical wavelength are physically contacted.

With this configuration, even if the optical waveguide edge plane is not obliquely processed, it is possible to greatly reduce the reflection on the optical waveguide edge plane and also possible to configure the bidirectional optical module where the optical waveguide can be attached and detached.

The invention according to claim 24 is an optically propagating apparatus including the bidirectional optical module according to any one of the preceding claims 1 to 23.

With this configuration, it is possible to attain the optically propagating apparatus having the same actions and effects as the inventions according to claims 1 to 23.

### BRIEF DESCRIPTION OF THE DRAWINGS

FIG. 1A is a view in which a semiconductor laser in a bidirectional optical module in a first embodiment of the present invention is displaced in a right side;

FIG. 1B is a view in which the semiconductor laser in the bidirectional optical module in the first embodiment of the present invention is displaced in a left side;

FIG. 2 is a main portion section view of a bidirectional optical module in a second embodiment of the present invention;

FIG. 3 is a main portion section view of a bidirectional optical module in a third embodiment of the present invention;

FIG. 4A is a view in which a sub-carrier to explain the effect of the bidirectional optical module in the second and third embodiments of the present invention is at a normal angle;

FIG. 4B is a view in which the sub-carrier to explain the effect of the bidirectional optical module in the second and third embodiments of the present invention is displaced counter-clockwise;

FIG. 4C is a view in which the sub-carrier to explain the effect of the bidirectional optical module in the second and third embodiments of the present invention is displaced clockwise;

FIG. 5 is a main portion section view of a bidirectional optical module in a fourth embodiment of the present invention;

FIG. 6 is a plan view showing a light receiving device in FIG. 5;

FIG. 7 is a side view showing the light receiving device in FIG. 5;

FIG. 8 is a main portion section view of a bidirectional optical module in a fifth embodiment of the present invention;

FIG. 9 is a plan view showing a light receiving device in FIG. 8;

FIG. 10 is a main portion section view of a bidirectional optical module in a sixth embodiment of the present invention;

FIG. 11 is a plan view showing a light receiving device in FIG. 10;

FIG. 12 is a side view showing the light receiving device in FIG. 10;

FIG. 13 is a main portion section view of a bidirectional optical module in a seventh embodiment of the present invention;

FIG. 14 is a plan view showing a light receiving device in FIG. 13;

FIG. 15 is a main portion section view of a bidirectional optical module in an eighth embodiment of the present invention;

FIG. 16 is a main portion section view of a bidirectional optical module in a ninth embodiment of the present invention;

FIG. 17 is a main portion section view of a bidirectional optical module in a tenth embodiment of the present invention;

FIG. 18 is a main portion section view of a bidirectional optical module in an eleventh embodiment of the present invention;

FIG. 19 is a main portion section view of a bidirectional optical module in a fifteenth embodiment of the present invention;

FIG. 20 is a main portion section view of a bidirectional optical module in an eighteenth embodiment of the present invention;

FIG. 21 is a main portion section view of a bidirectional optical module in a nineteenth embodiment of the present invention;

FIG. 22 is a main portion section view of a bidirectional optical module in a 21-th embodiment of the present invention;

FIG. 23 is a main portion section view of a bidirectional optical module in a 22-th embodiment of the present invention;

FIG. 24 is a main portion section view of a bidirectional optical module in a 23-th embodiment of the present invention; and

FIG. 25 is a configuration block diagram showing a conventional bidirectional optical unit.

### BEST MODE FOR CARRYING OUT THE INVENTION

### First Embodiment

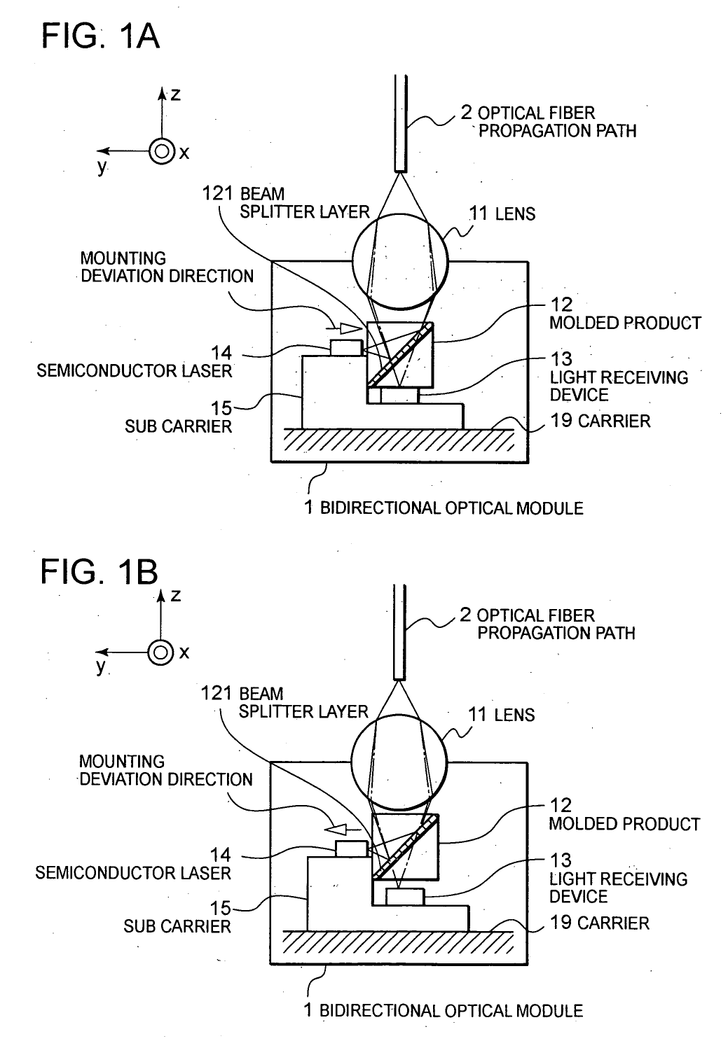

The embodiment of the present invention will be described below with reference to the drawings. FIGS. 1A, 1B show the main portion section view of a bidirectional optical module 1 in the first embodiment of the present invention. A lens 11, a molded product 12 and a light receiving device 13 are placed in an optical axis direction (z-direction) of an optical fiber propagation path 2. Also, a semiconductor laser 14 that is a light emitting device is placed in a y-direction orthogonal to the optical axis direction of the optical fiber propagation path 2. The lens 11 transmits and collects a received light from the optical fiber propagation path 2 and a transmitting light from the semiconductor laser 14.

The molded product 12 is made of the material transparent to the transmitting light and received light, and a beam splitter layer 121 is inclined at a predetermined angle (obliquely approximately 45°) and embedded. A sub-carrier 15 is such that the side shape viewed from an x-axis direction is formed in uprightly convex L-shaped two stages, and the lower surface is mounted on a flat upper surface of a carrier 19. In other words, the sub-carrier 15 has a stage portion, which constitutes an upper stage and a lower stage, and a bottom plane, and the light receiving device 13 is mounted on the flat surface of the lower stage of the sub-carrier 15 and at the lower position of the molded product 12, and the semiconductor laser 14 is mounted on the flat surface of the upper stage, and the side of the molded product 12 is mounted on the vertical side, and the respective surfaces are joined.

In the foregoing configuration, the received light outputted from the optical fiber propagation path 2 is collected by the lens 11, and a part or whole of the light is transmitted through the molded product 12 and inputted to the light receiving device 13. The semiconductor laser 14 outputs the transmitting light having a predetermined wavelength through a drive current modulated on the basis of a transmitting signal. The part or whole of the transmitting light is reflected by the beam splitter layer 121 and then collected by the lens 11, and inputted to the optical fiber propagation path 2.

With this configuration, the light receiving device 13 and the semiconductor laser 14 can be placed at the very close positions. Thus, as compared with the conventional bidirectional optical module, it can be configured by the smaller number of the parts. Consequently, the miniaturization and the lower cost can be attained. In such configuration where the foregoing light receiving device 13 and semiconductor laser 14 are placed at the close positions, the points that optimize the optical transmission/reception property are reduced. Thus, a case of requiring a high precision for the mounting of the semiconductor laser 14 may be considered. However, in the first embodiment of the present invention, by displacing the joint plane between the molded product 12 and the sub-carrier 15 in the upper and lower direction and also adjusting the horizontal position relation between the sub-carrier 15 and the lens 11, it is possible to optimize the optical transmission/reception property. Hence, this is configured so as to be able to relax the mounting precision of the semiconductor laser 14.

Here, FIG. 1A shows the example of the case where the mounting of the semiconductor laser 14 on the sub-carrier 15 is displaced in the direction closer to the molded product 12 on the y-axis (in the right direction on the drawing). In this case, by displacing the molded product 12 in the direction closer to the light receiving device 13 on the z-axis (the direction remoter from the optical fiber propagation path 2) with respect to the sub-carrier 15 and also displacing the sub-carrier 15 in the left direction of the drawing on the y-axis with respect to the carrier 19, it is possible to adjust the position relation to the lens 11.

FIG. 1B shows the example of the case where the mounting of the semiconductor laser 14 on the sub-carrier 15 is displaced in the direction remoter from the molded product 12 on the y-axis, oppositely to FIG. 1A. In this case, by displacing the molded product 12 in the direction remoter from the light receiving device 13 on the z-axis with respect to the sub-carrier 15 and also displacing the sub-carrier 15 in the right direction of the drawing on the y-axis with respect to the carrier 19, it is possible to adjust the position relation to the lens 11. In FIGS. 1A, 1B, it is known that the position relation between the semiconductor laser 14 and the lens 11 is equal, and the displacement in the y-axis direction of the semiconductor laser 14 can be absorbed, thereby suppressing the variation in the transmission property. Also, in FIGS. 1A, 1B, a position of a focus of a received light signal inputted to the light receiving device 13 is changed. However, by making the light receiving region of the light receiving device 13 sufficiently larger, it is possible to suppress the variation in the reception property.

### Second and Third Embodiments

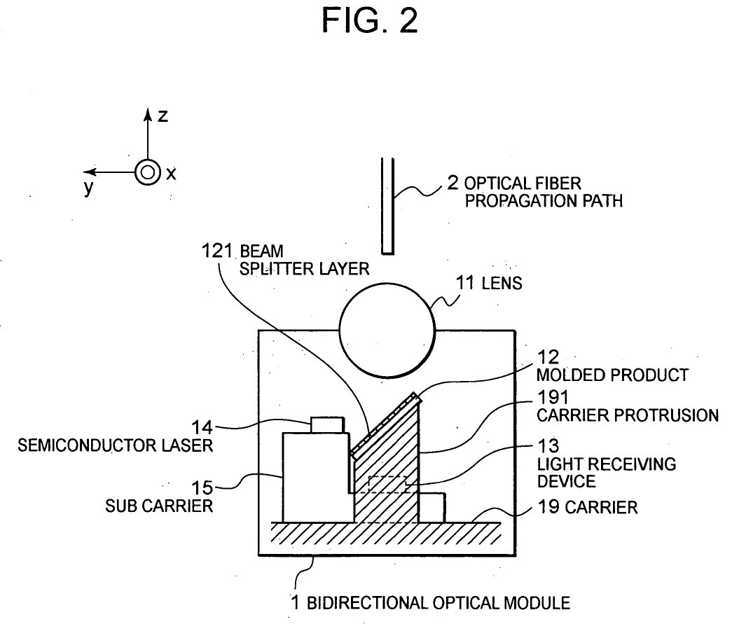

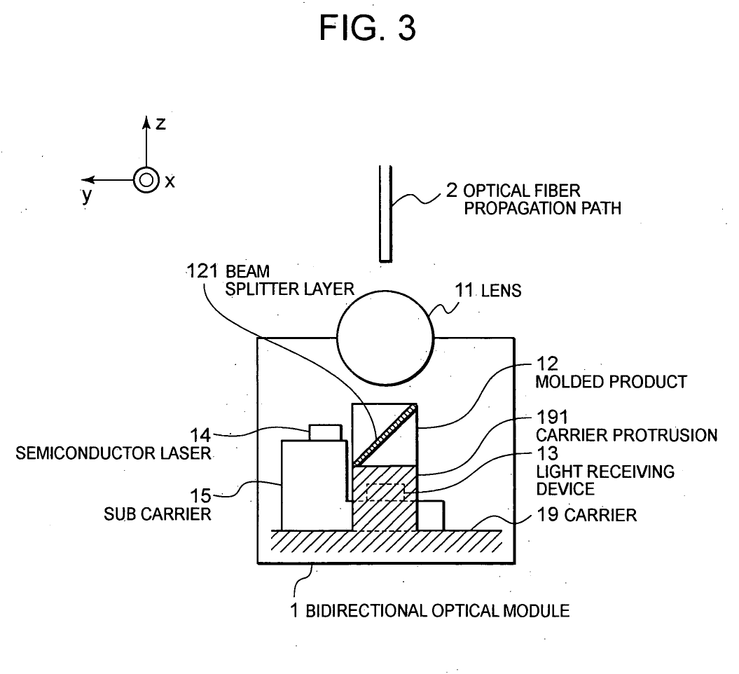

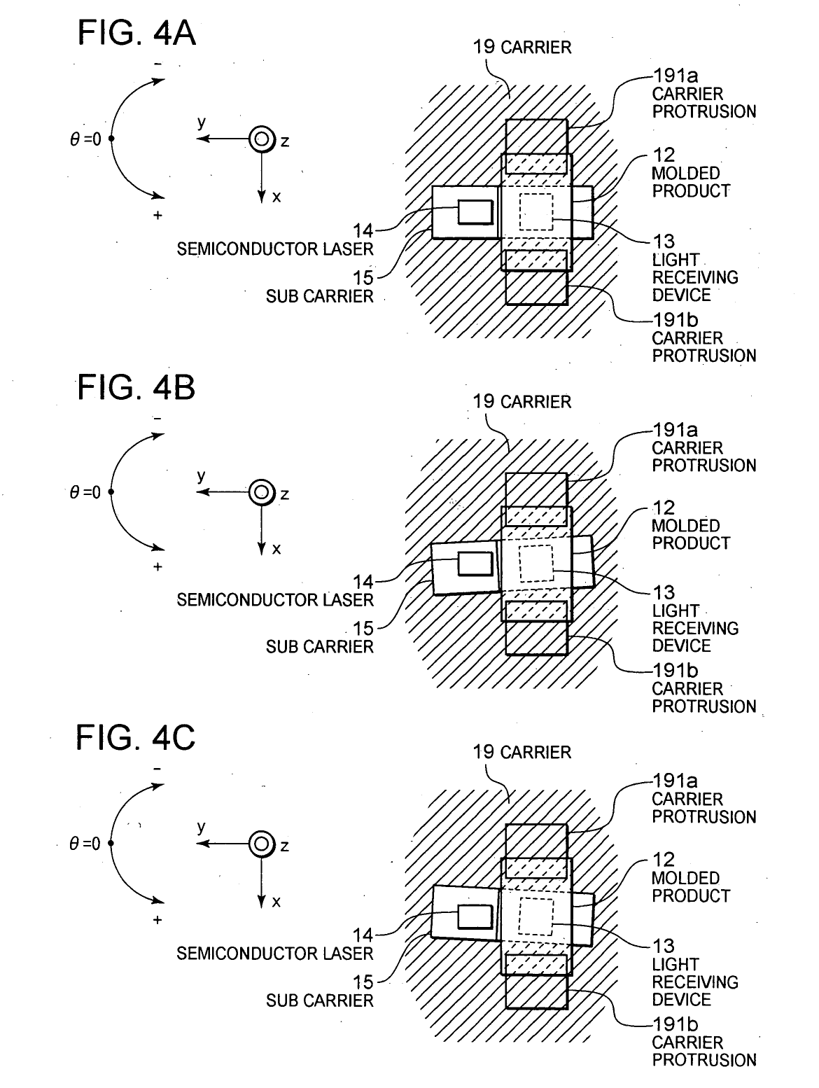

FIG. 2 and FIG. 3 show the main portion section views in the second and third embodiments of the present invention, respectively. The difference from the first embodiment in FIGS. 1A, 1B lies in the configuration where the molded product 12 is not the sub-carrier 15, and it is fixed on a pair of carrier protrusions 191a, 191b (refer to FIGS. 4A to 4C) acting as supporters, which are integrally formed on the carrier 19, so as to sandwich the light receiving device 13 on the lower stage of the sub-carrier 15, in the x-direction. Also, in the second embodiment of FIG. 2, the top plane of the carrier protrusion 191 is formed as the slant inclined at a predetermined angle (obliquely approximately 45°), and the molded product 12 in the shape of a flat plate is mounted thereon, and the beam splitter layer 121 is also formed on the surface of this molded product 12. In the third embodiment of FIG. 3, the top plane of the carrier protrusion 191 is flatly formed, and the molded product 12 of a rectangular parallelepiped is mounted thereon, and the beam splitter layer 121 is embedded in this molded product 12 obliquely at 45°.

Also in the second and third embodiments respectively shown in FIG. 2 and FIG. 3, similarly to the first embodiment of FIGS. 1A, 1B, the light receiving device 13 and the semiconductor laser 14 can be placed at the very close positions. Thus, as compared with the conventional bidirectional optical module, it can be configured by the smaller number of the parts, and the miniaturization and the lower cost can be attained. In the second embodiment and the third embodiment in FIG. 2 and FIG. 3, also by adjusting the position relation on the x-y plane between the molded product 12, the sub-carrier 15 and the lens 11, it is possible to optimize the optical transmission/reception property. Thus, they have the configuration that can relax the mounting precision of the semiconductor laser 14.

FIGS. 4A to 4C show the main portion plan views (x-y plan views) when the second and third embodiments respectively shown in FIG. 2 and FIG. 3 are viewed from above. FIG. 4A shows the optimal arrangement when the semiconductor laser 14 is precisely mounted at the predetermined position, and FIGS. 4B, 4C show the arrangement when the mounting direction of the semiconductor laser 14 is displaced on the x-y plane. In FIG. 4B, the mounting position of the sub-carrier 15 is rotated in a +θ direction with respect to the molded product 12, and in FIG. 4C, the mounting position of the sub-carrier 15 is rotated in a −θ direction with respect to the molded product 12. Hence, the position relations in the x-y direction between the semiconductor laser 14 and the molded product 12 are equal, and the displacement in the θ rotation direction of the semiconductor laser 14 can be absorbed. Then, it is understood that the variation in the transmission property can be suppressed. Also, in FIGS. 4B, 4C, although the central position of the light receiving device 13 is displaced, the light receiving region of the light receiving device 13 can be made sufficiently large, thereby suppressing the variation in the reception property.

### Fourth Embodiment

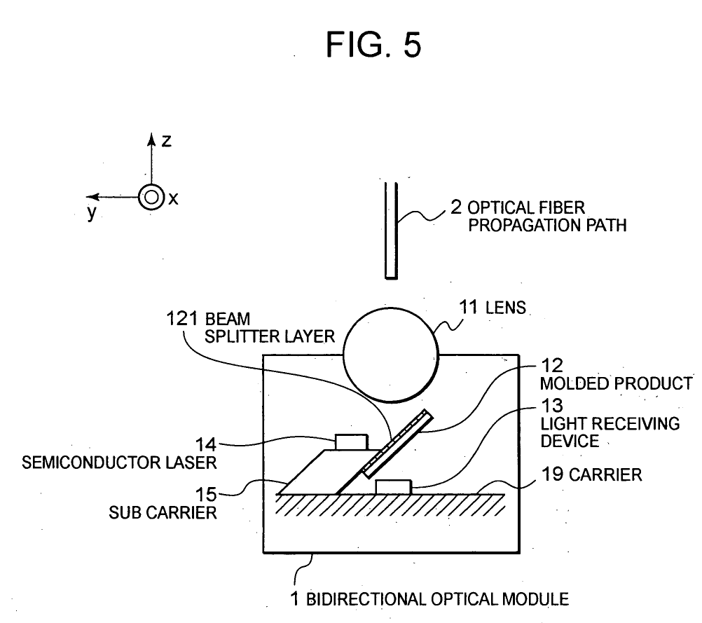

FIG. 5 shows the main portion section view of the fourth embodiment. The sub-carrier 15 is formed such that its side shape is a parallelogram and its oblique side is inclined at a predetermined angle (obliquely approximately 45°). Similarly to the second embodiment, the molded product 12 is flatly formed, and the beam splitter layer 121 is formed on the surface. Then, in such a way that the beam splitter layer 121 becomes at 45°, a part of the molded product 12 is bonded to a part of the side of the oblique side of the sub-carrier 15.

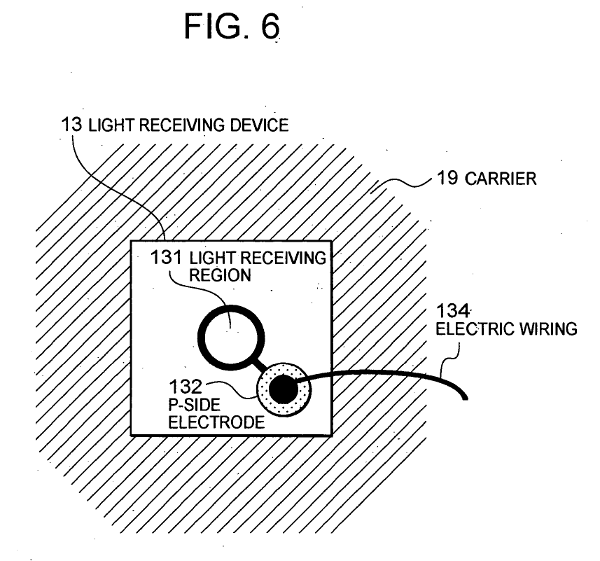

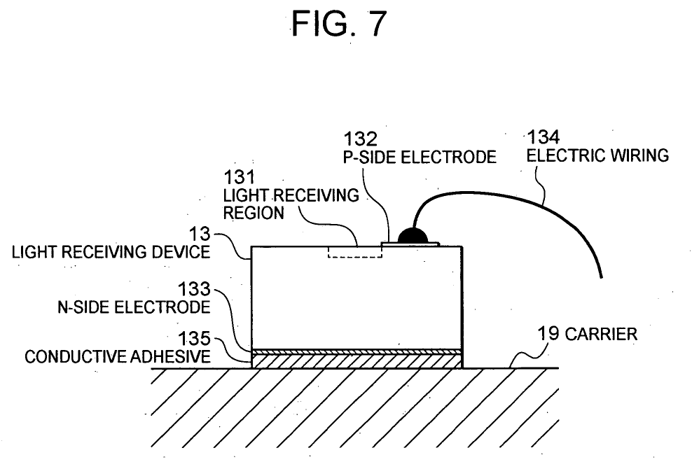

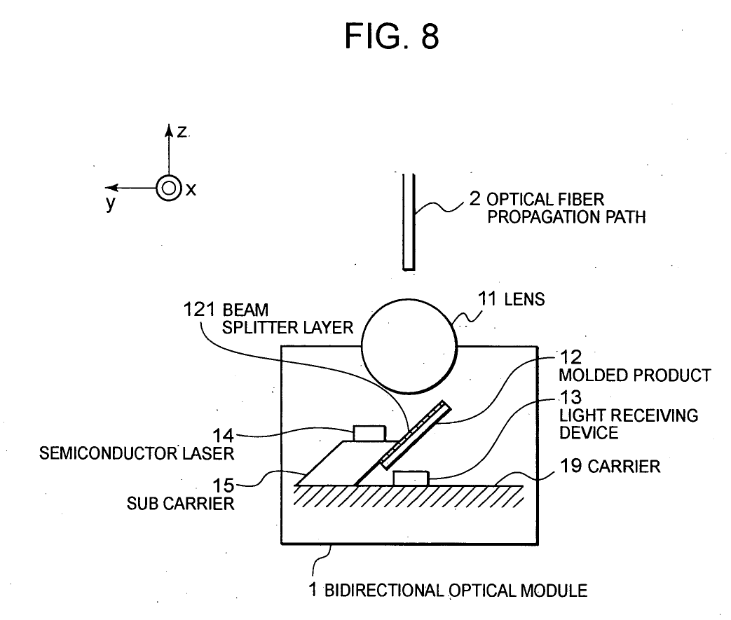

FIG. 6 and FIG. 7 are the plan view and side view of the light receiving device 13 used in the fourth embodiment, respectively. A P-side electrode 132 of the light receiving device 13 is located on the same plane as a light receiving region 131 and connected through an electric wiring 134 to a pre-amplifier at a later stage. An N-side electrode 133 is fixed through a conductive adhesive 135 to the carrier 19, and a potential is given through the carrier 19.

With this configuration, the light receiving device 13 and the semiconductor laser 14 can be placed at the very close positions. Thus, as compared with the conventional bidirectional optical module, it can be configured by the smaller number of the parts, and the miniaturization and the lower cost can be attained. Also, in this configuration, by adjusting the position relation between the sub-carrier 15, the light receiving device 13 and the lens 11, it is possible to optimize the optical transmission/reception property. Thus, this has the configuration that can relax the mounting precision of the semiconductor laser 14.

### Fifth Embodiment

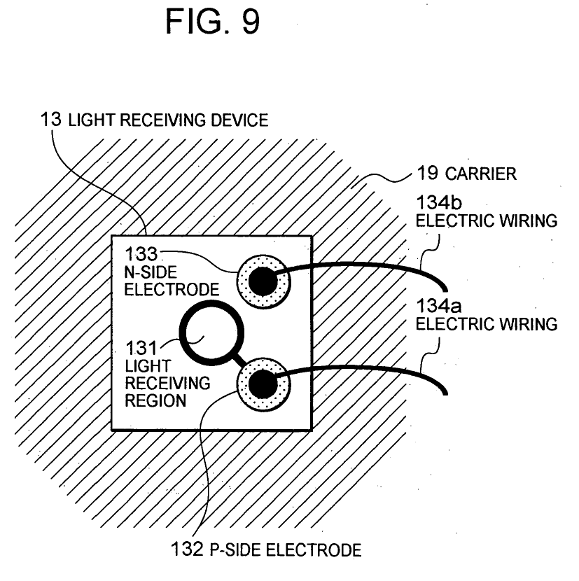

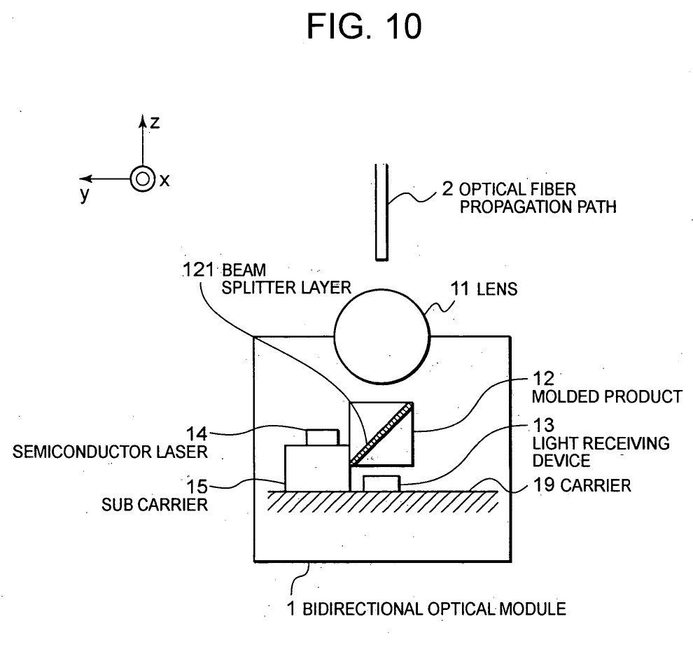

FIG. 8 shows the main portion section view of the fifth embodiment of the present invention, which is equal to the fourth embodiment in FIG. 5 except the light receiving device 13 shown in FIG. 9. The difference from the fourth embodiment lies in the configuration as shown in FIG. 9, in which the P-side electrode 132 and N-side electrode 133 of the light receiving device 13 are both located on the same plane as the light receiving region 131, and a potential of the N-side electrode 133 is given through an electric wiring 134a, and the P-side electrode 132 is connected through an electric wiring 134b to a pre-amplifier at a later stage. Consequently, it is possible to separate a potential of the carrier 19 and the potential of the light receiving device 13.

### Sixth Embodiment

FIG. 10 shows the main portion section view of the sixth embodiment of the present invention. In the first embodiment of FIGS. 1A, 1B, the light receiving device 13 is mounted on the carrier 19 and not the sub-carrier 15. Also, the sub-carrier 15 is formed as a rectangular parallelepiped, and the semiconductor laser 14 and the molded product 12 of a rectangular parallelepiped are mounted on the top plane and the vertical plane, respectively. That is, the difference from the fourth embodiment in FIG. 5 lies in the configuration where the beam splitter layer 121 is obliquely embedded in the molded product 12, and the sub-carrier 15 does not require the slant. Moreover, similarly to the first embodiment of FIGS. 1A, 1B, this has a merit that the distance between the semiconductor laser 14 and the lens 11 can be adjusted by displacing the joint plane between the sub-carrier 15 and the molded product 12.

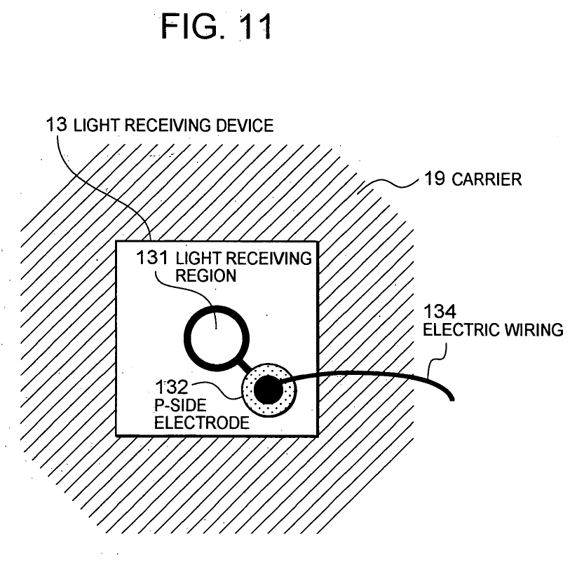

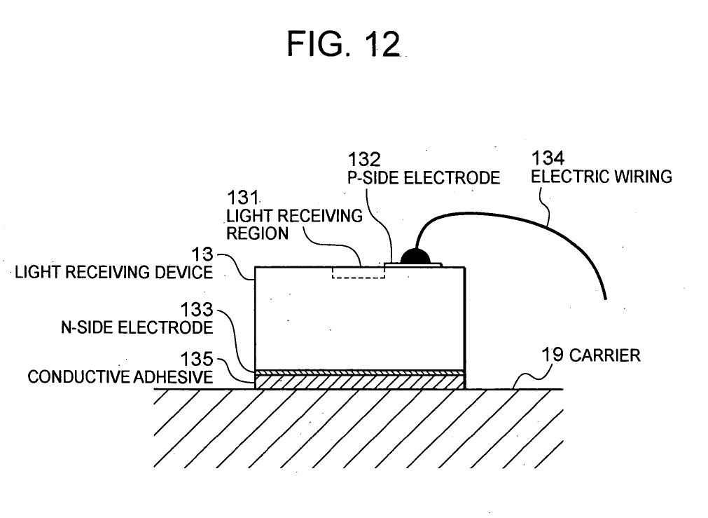

FIG. 11 and FIG. 12 show the plan view and side view of the light receiving device 13 used in the sixth embodiment, respectively. This is equal to the light receiving device 13 used in the fourth embodiment. The N-side electrode 133 of the light receiving device 13 is fixed through the conductive adhesive 135 to the carrier 19, and a potential is given through the carrier 19.

### Seventh Embodiment

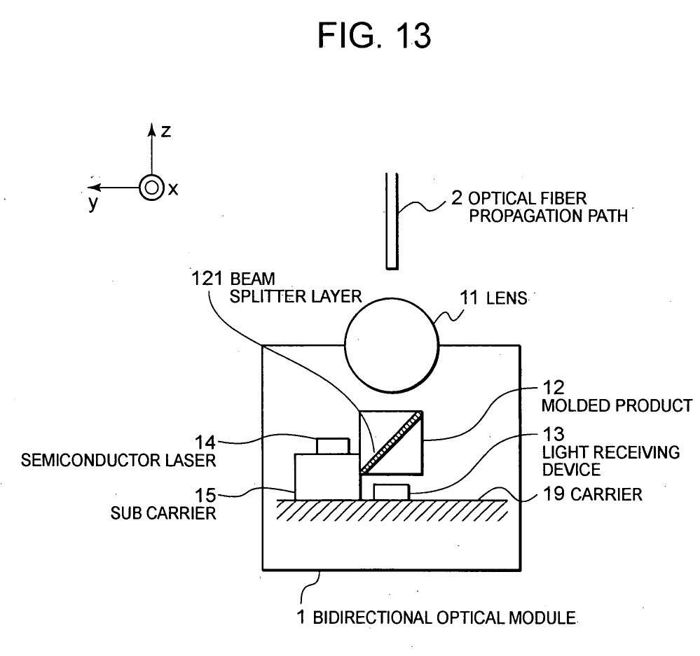

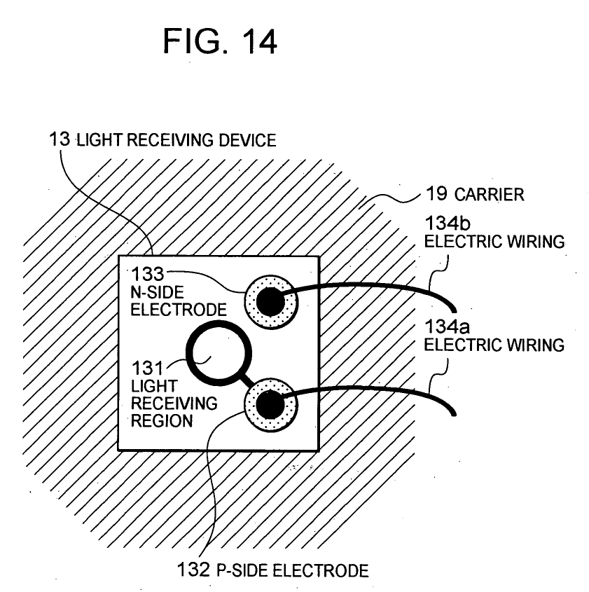

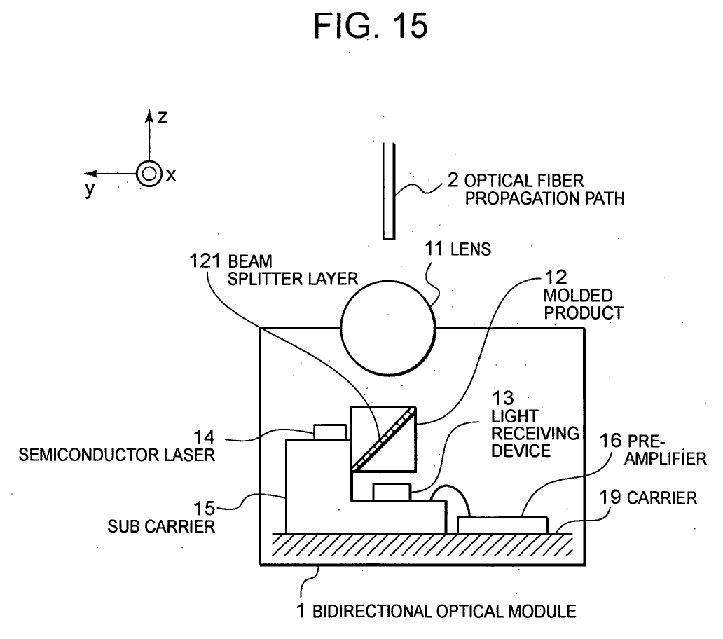

FIG. 13 shows the main portion section view of the seventh embodiment of the present invention, which is equal to the sixth embodiment except the light receiving device 13. The difference from the sixth embodiment lies in the configuration as shown in FIG. 14, in which similarly to the fifth embodiment, the P-side electrode 132 and N-side electrode 133 of the light receiving device 13 are both located on the same plane as the light receiving region 131, and the potential of the N-side electrode 133 is given through the electric wiring 134a, and the P-side electrode 132 is connected through the electric wiring 134b to the pre-amplifier at the later stage. Consequently, it is possible to separate the potential of the carrier 19 and the potential of the light receiving device 13.

### Eighth Embodiment

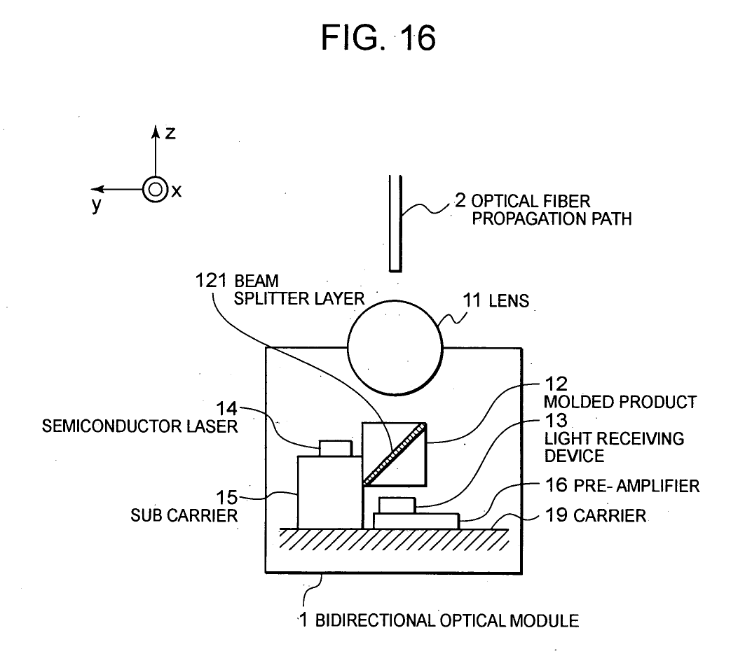

FIG. 15 shows the main portion section view of the eighth embodiment of the present invention, which differs from the first embodiment of FIGS. 1A, 1B, in that a pre-amplifier 16 is built in on the carrier 19 inside the bidirectional optical module 1, and the pre-amplifier 16 and the light receiving device 13 are closely placed. Consequently, not only a module package can be used as a shield case, but also the connection between the light receiving device 13 and the pre-amplifier 16 can be made shorter, which can improve a noise resistance.

### Ninth Embodiment

FIG. 16 shows the main portion section view of the ninth embodiment of the present invention, in which as compared with FIG. 15, the light receiving device 13 is mounted on the pre-amplifier 16, and the pre-amplifier 16 is mounted on the carrier 19.

With this configuration, the light receiving device 13 and the semiconductor laser 14 can be placed at the very close positions. Thus, as compared with the conventional bidirectional optical module, it can be configured by the smaller number of the parts. Consequently, the miniaturization and the lower cost can be attained. In this configuration, by displacing the joint plane between the molded product 12 and the sub-carrier 15 and also adjusting the position relation between the sub-carrier 15, the pre-amplifier 16 and the lens 11, it is possible to optimize the optical transmission/reception property. Hence, this is configured so as to be able to relax the mounting precision of the semiconductor laser 14. Moreover, the pre-amplifier 16 is build in the bidirectional optical module 1, and the pre-amplifier 16 and the light receiving device 13 are closely placed. Thus, the module package can be used as the shield case, and the connection between the light receiving device 13 and the pre-amplifier 16 can be made shorter, which can consequently improve the noise resistance.

### Tenth and Eleventh Embodiments

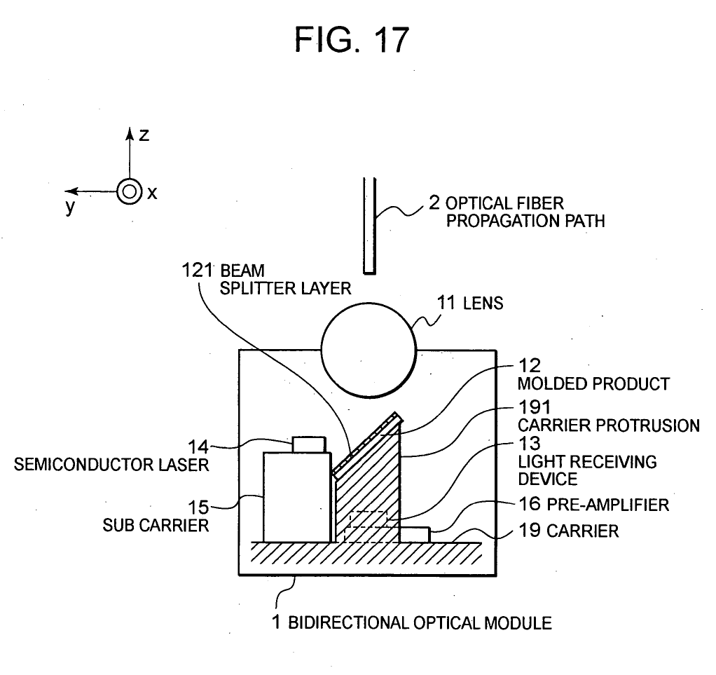

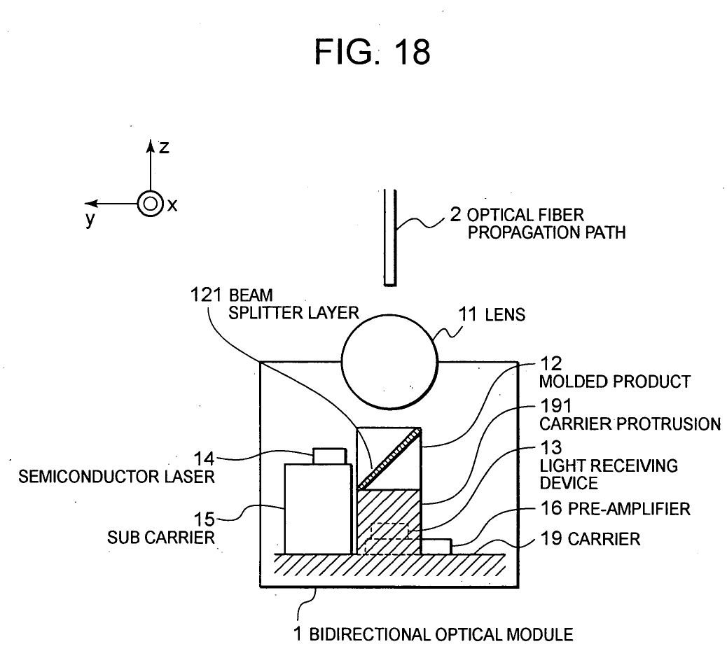

FIG. 17 and FIG. 18 show the main portion section views of the tenth and eleventh embodiments of the present invention, respectively. The difference from the ninth embodiment lies in the configuration where the molded product 12 is not fixed on the sub-carrier 15 and it is fixed on the pair of carrier protrusions 191a, 191b (refer to FIGS. 4A to 4C) acting as the supporters, which are formed on the carrier 19, so as to sandwich the sub-carrier 15 in the x-direction. Also, in the tenth embodiment of FIG. 17, the top plane of the carrier protrusion 191 is formed as the slant of 45°, and the molded product 12 in the shape of the flat plate is mounted thereon, and the beam splitter layer 121 is formed on the surface of this molded product 12. In the eleventh embodiment of FIG. 18, the top plane of the carrier protrusion 191 is flatly formed, and the molded product 12 of a rectangular parallelepiped is formed thereon, and the beam splitter layer 121 is embedded in this molded product 12 obliquely at 45°.

Also in the tenth and eleventh embodiments, similarly to the ninth embodiment, the light receiving device 13 and the semiconductor laser 14 can be placed at the very close positions. Thus, as compared with the conventional bidirectional optical module, it can be configured by the smaller number of the parts. Consequently, the miniaturization and the lower cost can be attained. Also, the pre-amplifier 16 is built in the bidirectional optical module 1, and the pre-amplifier 16 and the light receiving device 13 are closely placed. Thus, the module package can be used as the shield case, and the connection between the light receiving device 13 and the pre-amplifier 16 can be made shorter, which can consequently improve the noise resistance. Also, in the tenth and eleventh embodiments, by adjusting the position relation between the molded product 12, the sub-carrier 15, the pre-amplifier 16 and the lens 11, it is possible to optimize the optical transmission/reception property. Hence, this has the configuration that can relax the mounting precision of the semiconductor laser 14.

### Twelfth and Thirteenth Embodiment

In the twelfth embodiment of the present invention, the sub-carrier 15 is made of silicon. Also, in the thirteenth embodiment of the present invention, the sub-carrier 15 is made of aluminum nitride. Both of the twelfth and thirteenth embodiments can improve the heat dissipation property of the semiconductor laser 14.

### Fourteenth Embodiment

In the fourteenth embodiment of the present invention, a reflection protecting film is formed on a light input plane of the molded product 12, and a part or whole of a light output plane. Consequently, the attenuation of a light transmission/reception amount caused by reflection can be reduced. Also, if the light emitting plane of the semiconductor laser 14 is substantially parallel to one plane of the molded product 12, the external resonation of the semiconductor laser 14 can be suppressed.

### Fifteenth Embodiment

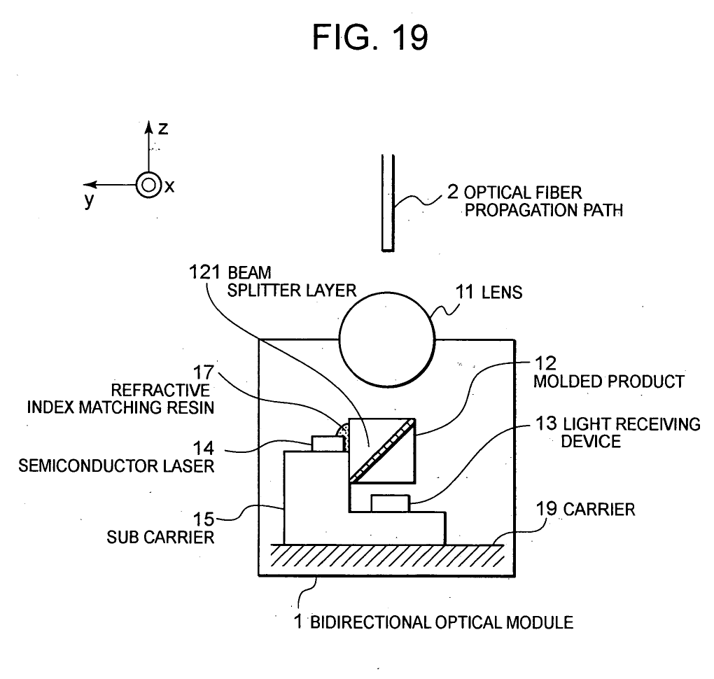

FIG. 19 shows the main portion section view of the fifteenth embodiment of the present invention, which differs from the first embodiment of FIGS. 1A, 1B in that a refractive index matching resin 17 is filled between the semiconductor laser 14 and the plane of the molded product 12 to which the output light of the semiconductor laser 14 is vertically inputted. Consequently, even if the light receiving plane of the semiconductor laser 14 is substantially parallel to one plane of the molded product 12, the external resonation of the semiconductor laser 14 can be suppressed.

### Sixteenth and Seventh Embodiment

In the sixteenth embodiment of the present invention, a member for dividing a predetermined wavelength by a preset rate is used for the beam splitter layer 121. The bidirectional optical module 1 of the same wavelength can be attained. In the seventeenth embodiment of the present invention, a wavelength selection type beam splitter is used for the beam splitter layer 121. Consequently, the bidirectional optical module 1 of two wavelengths can be attained.

### Eighteenth Embodiment

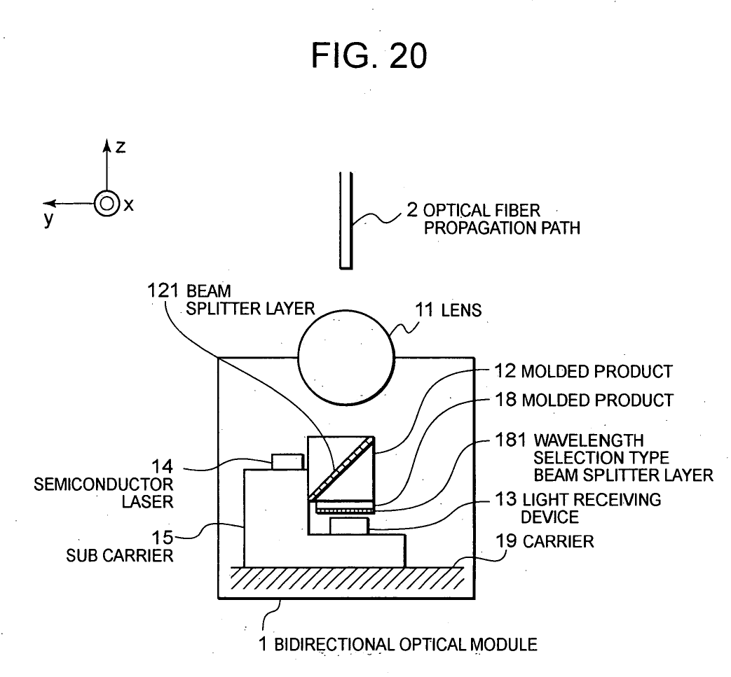

FIG. 20 shows the main portion section view of the eighteenth embodiment of the present invention, which differs from the first embodiment of FIGS. 1A, 1B in that a second molded product 18 having a wavelength selection type beam splitter 181 for reducing a light of a wavelength which should not be received by the light receiving device 13 is stuck on a part of the bottom plane of the molded product 12 (the plane of the light receiving device 13 side). Consequently, it is possible to reduce the light of the wavelength that should not be received by the light receiving device 13.

### Nineteenth and Twentieth Embodiments

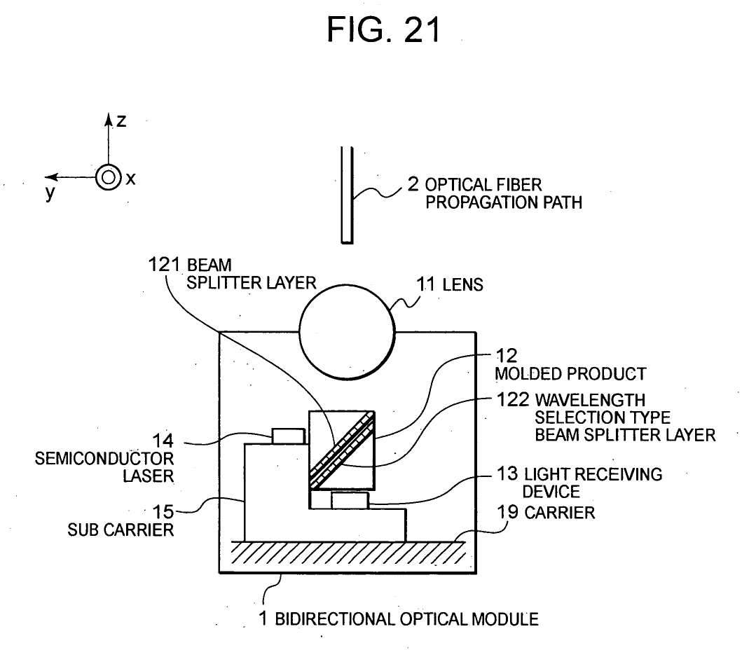

FIG. 21 shows the main portion section view of the nineteenth embodiment of the present invention, which differs from the first embodiment of FIGS. 1A, 1B in that a wavelength selection type beam splitter layer 122 for reducing the light of the wavelength which should not be received by the light receiving device 13 is additionally formed inside the molded product 12. Thus, it is possible to reduce the light of the wavelength that should not be received by the light receiving device 13. In the twentieth embodiment, the light receiving device 13 has the wavelength selection property to reduce the light of the wavelength which should not be received by the light receiving device 13. Thus, it is possible to reduce the light of the wavelength which should not be received by the light receiving device 13.

### 21-th Embodiment

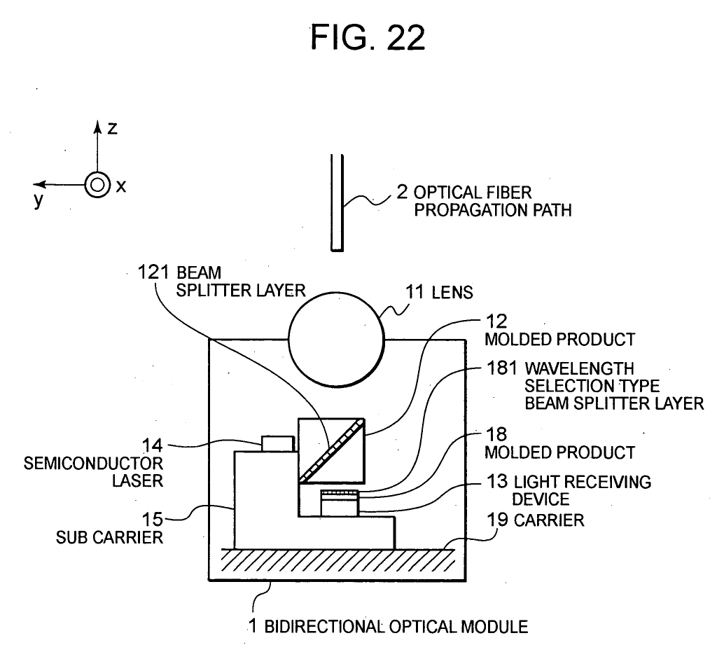

FIG. 22 shows the main portion section view of the 21-th embodiment of the present invention, which differs from the first embodiment of FIGS. 1A, 1B in that a second carrier 18 having a wavelength selection type beam splitter layer 181 for reducing the light of the wavelength which should not be received by the light receiving device 13 is stuck on the light input plane of the light receiving device 13. Thus, it is possible to reduce the light of the wavelength which should not be received by the light receiving device 13.

### 22-th Embodiment

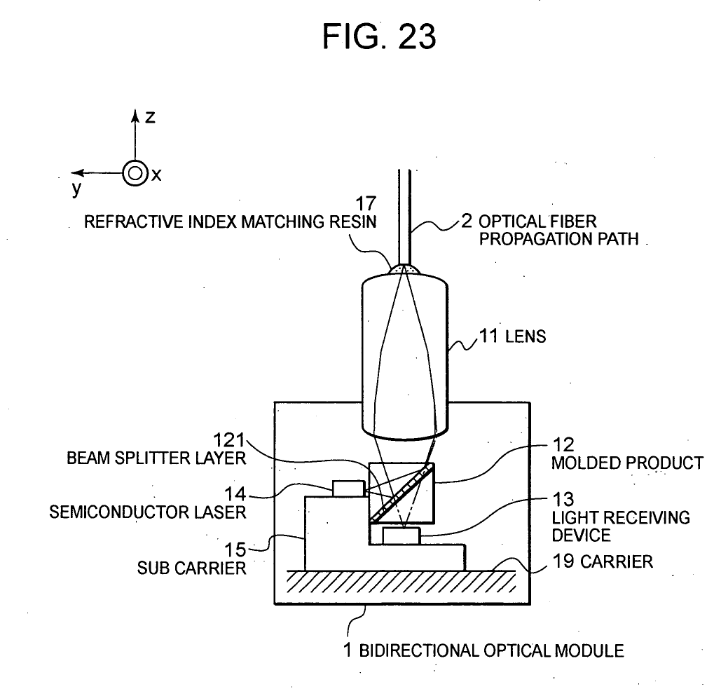

FIG. 23 shows the main portion section view of the 22-th embodiment of the present invention. This differs from the first embodiment of FIGS. 1A, 1B in that the lens 11 is a refractive index distribution type, and the lens 11 and the optical fiber propagation path 2 are bonded through the refractive index matching resin 17. Consequently, without obliquely processing the edge plane of the optical fiber propagation path 2, it is possible to greatly reduce the reflection on the edge plane of the optical fiber propagation path 2.

### 23-th Embodiment

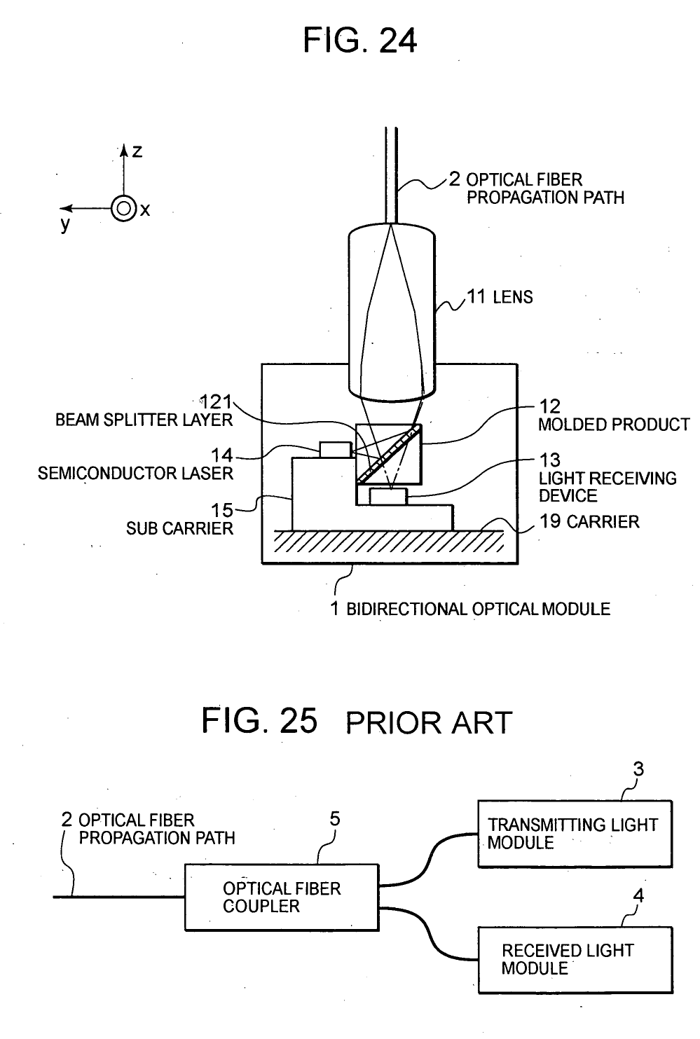

FIG. 24 shows the main portion section view of the 23-th embodiment of the present invention. This differs from the eighteenth embodiment of FIG. 20 in that the lens 11 and the optical fiber propagation path 2 are physically contacted. Consequently, without obliquely processing the edge plane of the optical fiber propagation path 2, it is possible to greatly reduce the reflection on the edge plane of the optical fiber propagation path 2 and also configure the bidirectional optical module 1 where the optical fiber propagation path 2 can be attached and detached.

### INDUSTRIAL USABILITY

As mentioned above, according to the inventions according to claims 1 to 8 and 24, the light receiving signal guided into this optical module from the optical waveguide can be collected by the lens, and inputted to the light receiving device placed at the very close position to the semiconductor laser that is the light emitting device, and the signal can be received. Thus, as compared with the conventional bidirectional optical module, it can be configured by the smaller number of the parts, which can attain the miniaturization and the lower cost. Also, in the configuration where the foregoing semiconductor laser and light receiving device are placed in the close positions, the position to optimize the optical transmission/reception property is reduced. Hence, the case in which the high precision is required to mount the semiconductor laser may be considered. However, in the configuration of the present invention, by displacing the joint plane between the molded product and the sub-carrier and adjusting the position relation between the sub-carrier and the lens, it is possible to optimize the optical transmission/reception property and consequently possible to relax the mounting precision of the semiconductor laser.

According to the invention noted in claim 9, in addition to the obtainment of the same action and effect as the invention noted in claim 1, the potential of the carrier and the potential of the light receiving device can be separated.

According to the invention noted in claims 10, 11, the pre-amplifier is built in the module, and the pre-amplifier and the light receiving device are placed at the close positions. Thus, the module package can be used as the shield case, and the connection between the light receiving device and the pre-amplifier can be made shorter, thereby improving the noise resistance.

According to the invention noted in claims 12, 13, it is possible to improve the heat dissipation property of the semiconductor laser.

According to the invention noted in claim 14, it is possible to reduce the attenuation of the transmitting/receiving light amount caused by the reflection, and if the light emitting plane of the semiconductor laser is substantially parallel to one plane of the molded product, it is possible to suppress the external resonation of the semiconductor laser.

According to the invention noted in claim 15, if the light emitting plane of the semiconductor laser is substantially parallel to the input plane of the molded product, filling the refractive index matching resin between them can suppress the external resonation of the semiconductor laser.

According to the invention noted in claim 16, it is possible to attain the bidirectional optical module of the same wavelength.

According to the invention noted in claim 17, it is possible to attain the bidirectional optical module of the two wavelengths.

According to the invention noted in claims 18 to 21, it is possible to reduce the light of the wavelength that should not be received by the light receiving device.

According to the invention noted in claim 22, even if the optical waveguide edge plane is not obliquely processed, it is possible to greatly reduce the reflection on the optical waveguide edge plane.

According to the invention noted in claim 23, even if the optical waveguide edge plane is not obliquely processed, it is possible to greatly reduce the reflection on the optical waveguide edge plane and also possible to configure the bidirectional optical module where the optical waveguide can be attached and detached.

1. A bidirectional optical module including:
a lens for transmitting and collecting a received light and a transmitting light;
a carrier having a flat plane in at least a part;
a sub-carrier having a stage portion constituting an upper stage and a lower stage, and a bottom plane, in which said bottom plane is bonded to said flat plane of said carrier;
a light emitting device, which is mounted on the upper stage of said sub-carrier and horizontally outputs the transmitting light;
a transparent molded product whose one plane is bonded to at least a part of one plane of said sub-carrier;
a beam splitter layer that is embedded in said molded product at a predetermined angle, and downwardly transmits the received light from above which is transmitted through said lens, and also upwardly reflects an output light of said light emitting device, and gives to said lens; and
a light receiving device that is mounted directly or through a different member on the lower stage of said sub-carrier, at a lower position of said transparent molded product, and receives the received light from above that is transmitted through said beam splitter layer.

2. A bidirectional optical module including:
a lens for transmitting and collecting a received light and a transmitting light;
a carrier having a flat plane in at least a part;
a supporting member that is fixed to said carrier and has a plane inclined against said flat plane at a predetermined angle;
a sub-carrier having a stage portion constituting an upper stage and a lower stage, and a bottom plane, in which said bottom plane is bonded to said flat plane of said carrier;
a light emitting device, which is mounted on the upper stage of said sub-carrier and horizontally outputs the transmitting light;
a transparent molded product whose one plane is bonded to at least a part of said inclined plane of said supporting member;
a beam splitter layer that is attached to said molded product, and downwardly transmits the received light from above which is transmitted through said lens, and also upwardly reflects an output light of said light emitting device, and gives to said lens; and
a light receiving device that is mounted directly or through a different member on the lower stage of said sub-carrier, at a lower position of said transparent molded product, and receives the received light from above that is transmitted through said beam splitter layer.

3. A bidirectional optical module including:
a lens for transmitting and collecting a received light and a transmitting light;
a carrier having a flat plane in at least a part;
a supporting member fixed to said carrier;
a sub-carrier having a stage portion constituting an upper stage and a lower stage, and a bottom plane, in which said bottom plane is bonded to said flat plane of said carrier;
a light emitting device, which is mounted on the upper stage of said sub-carrier and horizontally outputs the transmitting light;
a transparent molded product whose one plane is bonded to at least a part of one plane of said supporting member;
a beam splitter layer that is obliquely embedded in said molded product at a predetermined angle, and downwardly transmits the received light from above which is transmitted through said lens, and also upwardly reflects an output light of said light emitting device, and gives to said lens; and
a light receiving device that is mounted directly or through a different member on the lower stage of said sub-carrier, at a lower position of said transparent molded product, and receives the received light from above that is transmitted through said beam splitter layer.

4. A bidirectional optical module including:
a lens for transmitting and collecting a received light and a transmitting light;
a carrier having a flat plane in at least a part;
a sub-carrier that has an inclination plane inclined against said flat plane at a predetermined angle, and a top plane and a bottom plane, in which said bottom plane is bonded to said flat plane of said carrier;
a light emitting device, which is mounted on said top plane of said sub-carrier and horizontally outputs the transmitting light;
a transparent molded product whose one plane is bonded to at least a part of said inclination plane of said sub-carrier;
a beam splitter layer that is attached to said molded product, and downwardly transmits the received light from above which is transmitted through said lens, and also upwardly reflects an output light of said light emitting device, and gives to said lens; and
a light receiving device that is mounted directly or through a different member on said flat plane of said carrier, at a lower position of said transparent molded product, and receives the received light from above that is transmitted through said beam splitter layer.

5. A bidirectional optical module including:
a lens for transmitting and collecting a received light and a transmitting light;
a carrier having a flat plane in at least a part;
a sub-carrier having a top plane and a bottom plane, in which said bottom plane is bonded to said flat plane of said carrier;
a light emitting device, which is mounted on said top plane of said sub-carrier and horizontally outputs the transmitting light;
a transparent molded product whose one plane is bonded to at least a part of one plane of said sub-carrier;
a beam splitter layer that is embedded in said molded product at a predetermined angle, and downwardly transmits the received light from above which is transmitted through said lens, and also upwardly reflects an output light of said light emitting device, and gives to said lens; and
a light receiving device that is mounted directly or through a different member on said flat plane of said carrier, at a lower position of said transparent molded product, and receives the received light from above that is transmitted through said beam splitter layer.

6. A bidirectional optical module including:
a lens for transmitting and collecting a received light and a transmitting light;
a carrier having a flat plane in at least a part;
a supporting member that is fixed to said carrier and has a plane inclined against said flat plane at a predetermined angle;
a sub-carrier having a top plane and a bottom plane, in which said bottom plane is bonded to said flat plane of said carrier;
a light emitting device, which is mounted on said top plane of said sub-carrier and horizontally outputs the transmitting light;
a transparent molded product whose one plane is bonded to at least a part of said inclined plane of said supporting member;
a beam splitter layer that is attached to said molded product, and downwardly transmits the received light from above which is transmitted through said lens, and also upwardly reflects an output light of said light emitting device, and gives to said lens; and
a light receiving device that is mounted directly or through a different member on said flat plane of said carrier, at a lower position of said transparent molded product, and receives the received light from above that is transmitted through said beam splitter layer.

7. The bidirectional optical module according to claim 1, wherein said predetermined angle is 45°.

8. The bidirectional optical module according to claims 4, wherein said carrier is conductive, an N-side electrode of said light receiving device is formed on the bottom plane of said light receiving device, said N-side electrode is bonded through a conductive adhesive to a surface of said carrier, and a P-side electrode of said light receiving device is formed on the top plane of said light receiving device.

9. The bidirectional optical module according to claims 4, wherein both of the P-side electrode and N-side electrode of said light receiving device are formed on the top plane of said light receiving device, and said P-side electrode and N-side electrode are electrically insulated from said carrier.

10. The bidirectional optical module according to claim 1, where a pre-amplifier for amplifying a light receiving signal generated by said light receiving device is placed in the vicinity of said light receiving device on said carrier.

11. The bidirectional optical module according to claim 1, wherein said different member is a pre-amplifier that is mounted on a surface of said carrier or said sub-carrier and amplifies the light receiving signal generated by said light receiving device.

12. The bidirectional optical module according to claim 1, wherein said sub-carrier is made of silicon.

13. The bidirectional optical module according to claim 1, wherein said sub-carrier is made of aluminum nitride.

14. The bidirectional optical module according to claim 1, wherein a reflection protecting film is formed on a light input plane of said molded product and a part or whole of a light output plane.

15. The bidirectional optical module according to claim 1, wherein a refractive index matching resin is filled between said light receiving device and said molded product.

16. The bidirectional optical module according to claim 1, wherein said beam splitter divides a predetermined wavelength by a preset rate.

17. The bidirectional optical module according to claims 1, wherein said beam splitter is a wavelength selection type beam splitter.

18. The bidirectional optical module according to claim 1, wherein a second molded product having a wavelength selection type beam splitter layer for reducing a light of a wavelength that should not be received by said light receiving device is stuck on a part or whole of a surface of said molded product.

19. The bidirectional optical module according to claim 1, wherein a wavelength selection type beam splitter layer for reducing a light of a wavelength that should not be received by said light receiving device is additionally formed on a part or whole of an inside or surface of said molded product.

20. The bidirectional optical module according to claim 1, wherein said light receiving device has a wavelength selection property for reducing a light of a wavelength that should not be received.

21. The bidirectional optical module according to claim 1, wherein a second molded product having a wavelength selection type beam splitter layer for reducing a light of a wavelength that should not be received by said light receiving device is stuck on a part or whole of a light input plane of said light receiving device.

22. The bidirectional optical module according to claim 1, wherein said lens and an optical waveguide are bonded with refractive index matching resin.

23. The bidirectional optical module according to claim 1, wherein said lens and optical wavelength are physically contacted.

24. An optically propagating apparatus including the bidirectional optical module according to claim 1.
